(19) United States
(12) Patent Application Publication
(10) Pub. No.: US 2025/0317541 A1
(43) Pub. Date: Oct. 9, 2025

(54) SYSTEMS AND METHODS FOR NEURAL RADIANCE FIELD VIDEO COMPRESSION

(71) Applicant: Lifecast Incorporated, Menlo Park, CA (US)

(72) Inventor: Forrest Briggs, Sebastopol, CA (US)

(21) Appl. No.: 19/173,499

(22) Filed: Apr. 8, 2025

Related U.S. Application Data
(60) Provisional application No. 63/631,610, filed on Apr. 9, 2024.

(51) Int. Cl. H04N 13/122; H04N 19/597

(52) U.S. Cl. CPC H04N 13/122; H04N 19/597

(57) ABSTRACT

Systems and methods for neural radiance field video compression are described. One aspect includes a computing system receiving a plurality of images. The computing system may process the images to generate a radiance field model, and transform the radiance field model into an image sequence in a compressed format. The compressed image sequence may be rendered on a display device.

### BACKGROUND

This application claims the priority benefit of provisional patent application No. 63/631,610 titled “Systems for Neural Radiance Field Video Compression and Real-Time Rendering” filed on Apr. 9, 2024, the disclosure of which is incorporated by reference herein in its entirety.

### TECHNICAL FIELD

The present disclosure relates to systems and methods configured to render three-dimensional (3D) virtual reality (VR)/augmented reality (AR)/mixed reality (MR)/extended reality (XR) video on an associated display device while accounting for movement of a user's head in six degrees of freedom (6DOF).

### BACKGROUND ART

Current-generation 3D VR video formats such as VR180 and omnidirectional stereo are immersive, and are often rendered by projecting a texture for the left and right eye on spherical geometry that is very far away. This approach results in the user seeing stereoscopic views which respond only to their head rotation, but not translation (for example, as tracked by a head-mounted display). These purely stereoscopic formats do not enable rendering novel views from arbitrary poses with 6DOF. This limitation can cause motion sickness for a user, because if they move their head, their vestibular system perceives motion, while their eyes will not see a corresponding motion. Even rotating while staying in place causes enough translation to be subtly incorrect without 6DOF rendering. 6DOF is necessary to avoid motion sickness for a user, but it is much more difficult to create, edit, compress, and render 6DOF video. The current state of the VR video industry is that the vast majority of video is not 6DOF, due to the technical challenges with creating it.

### SUMMARY

Aspects of the invention are directed to systems and methods for distilling radiance fields into an immersive layered depth image representation, which enables 6DOF real-time rendering from novel views, for both static and video scenes.

One aspect presents a method that includes a computing system receiving a plurality of images. These images may be a part of a video stream associated with a 6DOF VR rendering of a scene. The computing system may process the images to generate a radiance field model. The method may include transforming the radiance field model into an image sequence in a compressed format, and then rendering the compressed image sequence on a display device. Other aspects may include apparatuses that implement the above method.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting a computer system architecture configured to perform neural radiance field (NeRF) video compression.

FIG. 2 is a flow diagram depicting a method to perform NeRF video compression.

FIG. 3 is a block diagram depicting a processing system architecture configured to implement aspects of the systems and methods described herein.

FIG. 4 is a flow diagram depicting a method to obtain a final representation of a pixel.

FIG. 5 is a geometric representation of a two-dimensional (2D) image view of an equiangular projection.

FIG. 6 is a geometric representation of a 3D view of an equiangular projection.

FIG. 7 is an illustration comparing an 8-bit rendering with a 12-bit rendering.

FIG. 8 is an illustration depicting an example of a compressed image format that contains a layered depth image.

FIG. 9 is a geometric representation of a divided space.

FIG. 10 is an illustration depicting an example of a computer-generated 2D rendering superimposed over a real-world rendering.

FIG. 11 is an illustration depicting a user view based on a user interaction with a VR rendition.

FIG. 12 is an illustration depicting a user view based on a user interaction with a VR rendition.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, a magnetic storage device, and any other storage medium now known or hereafter discovered. Computer program code for carrying out operations of the present disclosure may be written in any combination of one or more programming languages. Such code may be compiled from source code to computer-readable assembly language or machine code suitable for the device or computer on which the code can be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It is also noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Aspects of the systems and methods described herein are related to using NeRFs to render 3D VR video on an associated display device, while accounting for motion of a user's head in 6DOF.

NeRFs are a family of algorithms and methods in computer vision for 3D scene reconstruction from multiple input images, and photorealistic novel-view synthesis. Some of the known limitations of NeRF include being computationally intensive and slow to train, slow to render, requiring many input images, and only being applicable to static scenes (not video) in the basic formulation. Many extensions of NeRF have been proposed, aiming to address these and other limitations, with varying degrees of practical success and utility. It remains an open problem to simultaneously address all of the limitations of NeRF, while preserving photorealistic rendering, in a convenient and practical system.

NeRF and related methods generally work by defining a radiance field, which is a function which maps points in 3D space, and a ray direction, to a color and a density. In the case of NeRF, the radiance field is stored in a neural network, while in other related methods the radiance field is stored in one or more data structures which may include neural components. Rendering with NeRF is done by volumetric ray marching, sampling the radiance field at each of several points along the ray corresponding to each pixel, then blending the sampled colors according to alpha weights derived from the density field and ray step size. The volumetric rendering and radiance field model are typically implemented in a deep learning framework such as Torch or TensorFlow, and the model weights are obtained by minimizing a loss function which compares the ground-truth pixel colors from training images, with the predictions of the model's radiance field and volumetric rendering. The whole process is differentiable, which enables optimization via stochastic gradient descent.

In the current art, layered depth images (LDIs) are a 3D scene representation designed for novel view synthesis.

The systems and methods described herein implement a system for reconstructing, compressing, and rendering of photorealistic light field video in substantially real time, with a more practical format as comparted to the prior art, while deploying computationally more efficient processing as compared to prior work.

In one aspect, neural radiance fields are baked into layered depth images in inflated equiangular projection, with inverse depth maps stored via a 12-bit error correcting code in an 8-bit/channel container. The final representation can be compressed using conventional H.264, H.265, VP9, or ProRes formats, streamed over the internet, edited in existing tools, and rendered in real-time on mobile VR devices, in a web browser, or in game engines such as Unity and Unreal (open source implementations may be provided for all of these platforms). The methods described herein are relatively simple and compatible with any 3D or 4D radiance field.

The systems and methods described herein may be configured for capturing, rendering, editing, and deploying “immersive volumetric video”. The term “immersive” generally suggests that the video is suitable for viewing on mobile VR/AR/MR devices with a sufficient field of view for a user to be immersed in the viewing experience. One aspect is focused on fields of view close to 180° (as opposed to 360°, which is another flavor of immersive video).

In one aspect, the term “volumetric” is generally used to refer to a type of 3D video which supports photorealistic novel view synthesis from arbitrary poses with 6 degrees of freedom (6DOF). Photorealistic implies handling complex phenomena that appear in the real world, such as thin structures, partially transparent materials, and view-direction dependent effects. The proposed system can also render video and/or images on “holographic” (glasses-free 3D) displays such as the Looking Glass Portrait.

Different from most other “volumetric” video, the systems and methods described herein focus on inside-out capture of hemispherical scenes instead of outside-in capture of a single subject. One problem to be addressed might also be called light field video, or 4D/time-varying neural radiance fields. The term “video” generally refers to supporting capture of time-varying scenes, although the proposed methods work for static capture as well.

Some aspects of the systems and methods described herein are designed based on the following criteria:
Photorealistic 6DOF novel view synthesis with near 180° field of view, within a small viewing volume (about 0.5m radius).
Video can be compressed using universally supported features of conventional codecs such as H.264.
Video format should be editable (at least basic cuts) in existing video tools.
Video can be decoded and rendered in real time (or substantially real time) on a wide variety of platforms with relatively little GPU power.
The spatial resolution of the video must be high enough to appear sharp in VR displays.
Processing and encoding cannot be prohibitively slow.
Static or dynamic scenes can be captured with any camera system a user has at their disposal, ranging from a phone, to a light field array.

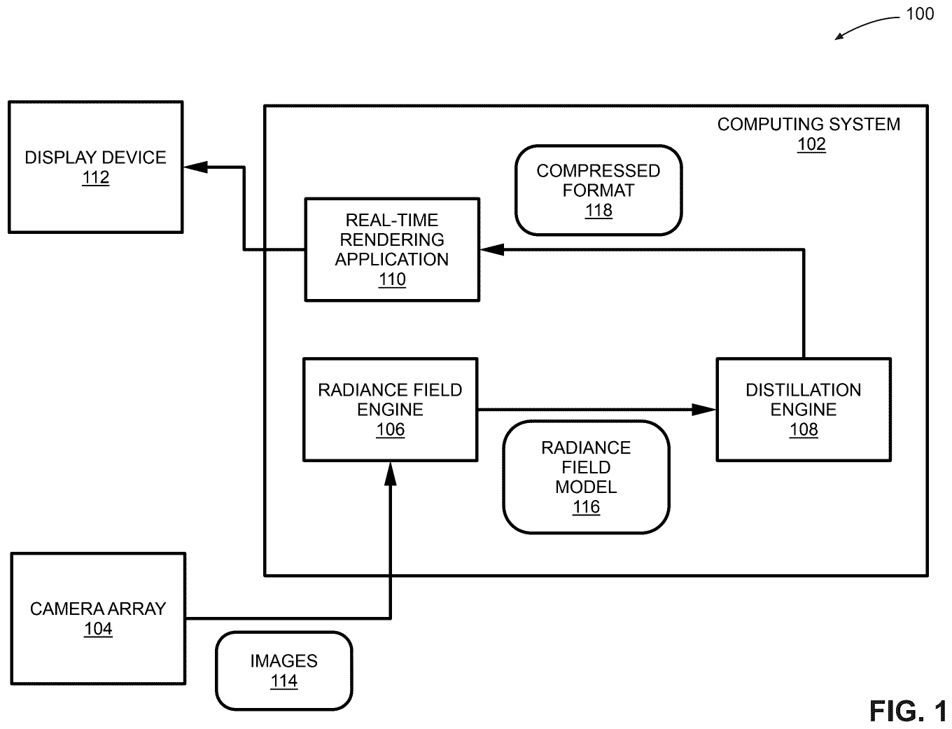

FIG. 1 is a block diagram depicting a computer system architecture 100 configured to perform neural radiance field (NeRF) video compression. As depicted, computer system architecture 100 includes computing system 102, camera array 104, and display device 112. Computing system 102 further includes radiance field engine 106, distillation engine 108, and real-time rending application 110.

In an aspect, camera array 104 may include one or more cameras configured to capture independent sequences of still images, or generate independent video streams, as images 114. Examples of image formats that can be output by camera array 104 include.jpeg,.tiff/.tif,. heif,.png, raw image formats, etc. Examples of video streams that can be output by camera array 104 include H.264, H.265, VP9, ProRes, raw video formats, etc. Camera array 104 may be configured to capture video streams that may be processed by computing system 102 to generate a 3D rendition of a scene captured by camera array 104, displayed on display device 112.

Camera array 104 can consist of any suitable collection of one or more image sensors and lenses which capture either static images or a time series of images (video). Camera array 104 may be at a fixed position for the full duration of a recording, or it may be moving (in which case other parts of computing system 102 can be configured to estimate the motion of camera array 104). For example camera array 104 could consist of just a single phone capturing a normal video of anything as usual. Or, camera array 104 could consist of an array of 40+cameras on a hemispherical dome, all synchronized to capture simultaneous frames of video.

The camera array 104 can include various different types of lenses, e.g., low distortion, rectilinear, or fisheye lenses. Some further examples of Camera Arrays include: phones with multiple image sensors and lenses, wearable 3D cameras such as glasses, AR/VR/MR/XR headsets, drones with cameras, robots with cameras, motor vehicles with cameras, specialized VR cameras such as 360 degree cameras and VR180 cameras, and light field camera arrays. One of the advantages of systems and methods described herein is that these are flexible about the input camera array, since it is possible to construct a 3D or 4D radiance field from any of these input sources.

In one embodiment, images 114 are received by radiance field engine 106. Radiance field engine 106 may be configured to process images 114 to generate/output radiance field model 116. To generate radiance field model 116, radiance field engine 106 may use any combination of techniques such as a neural multi-resolution hashmap, using importance sampling from a proposal network, etc. In another example, Gaussian splatting may be used as a factorization of a radiance field by radiance field engine 106. In other examples, image-based rendering techniques are incorporated into the radiance engine 106. The output of the radiance field engine is radiance field model 116, which is a model which maps points and ray directions to colors and densities.

Radiance field engine 106 may reconstruct a static scene (e.g., if the input data from camera array 104 is of a static scene and the camera array 104 is moved to capture the static scene from different points of view). In other embodiments, the radiance field engine 106 reconstructs a time-varying scene, either by independently estimating a 3D radiance field for each frame of video, or by estimating a 4D radiance field with an additional input time dimension.

In some embodiments, the radiance field engine 106 includes one or more components trained on external datasets which are used to fill in missing data in parts of the scene which are not sufficiently covered by the input images from camera array 104, or generally to improve radiance field reconstruction in a “one-shot” or “few-shot” scenario. This is particularly relevant to the construction of 4D radiance fields from camera array 104 with only a small number of image sensors and lenses such as a typical phone, which may see the scene from only one or a few close-together points of view at any given moment. In such cases a 4D radiance field model can still be reconstructed, while using some machine learning to resolve inherent ambiguities.

Part of the radiance field model 116 can be considered a “foundation model” for radiance fields, and it may be trained via unsupervised or semi-supervised methods on a large collection of images or video data to learn priors about the real world. In some embodiments, some or all of a 3D or 4D radiance field is created not based on real world images, but instead based on a text prompt or description of a desired scene. For example, a generative model may be used to construct a radiance field model from a text prompt. A generative model may also be used to create more detail in parts of a scene that are not covered by real cameras, while keeping the detail available from real images. In such cases, the same approach for distillation, compression, and real-time render may still be used. The construction of prompts may be mediated by a language model.

In an aspect, distillation engine 108 receives radiance field model 116. Distillation engine 108 may be configured to transform radiance field model 116 into a compressed video or image sequence format, to generate compressed format 118. Compressed format 118 may be configured for real-time (or near real-time) rendering and/or internet streaming. In an aspect, compressed format 118 is comprised of a layered depth image with 3 layers, in inflated equiangular projection, using an error-correcting code to represent 12 bits of accuracy in inverse depth maps, with different parts of the RGBA and inverse depth encoded in different regions of a single image frame of video.

In some embodiments, various parameters of the layered depth image in compressed format 118 are different, such as the number of layers, the associated projection, the encoding of depth maps, the layout of where different channel components or stored, or including other data streams. A multi-view video compression codec may be used to store the different layers and channels, rather than storing them in different regions of the same image.

In some embodiments, a video compression codec that supports higher bit depths for specific channels is used to store (inverse) depth maps. In some embodiments, additional channels are present which store data relevant to rendering view-dependent effects such as specular highlights, e.g., parameters of a model for spherical harmonic colors.

A functionality of distillation engine 108 may be similar to how one might render a radiance field to a 2D image, i.e., for each pixel find a corresponding ray direction and ray march that ray by sampling the radiance field at N points along the ray, then volumetrically blend the sampled colors and densities to obtain the final for the pixel. Along these lines, one color is obtained per layer by blending only the samples within the corresponding spherical shell. An inverse depth value can be computed for each pixel/layer as well as the weighted sum of inverse depth for samples within the shell.

In an aspect an LDI may be directly constructed in equiangular or inflated equiangular projection (any other projection may be used as well), to obtain a ray direction for each output pixel based on the definition of the projection. In some embodiments, a plurality of shells associated with the LDI may have the same radius for all rays/pixels. In other embodiments, the shells have a different radius for each ray/pixel, which can improve reconstruction quality, e.g., with these radii chosen based on quantiles of a local depth histogram, or any other heuristic.

Real-time rendering application 110 may receive compressed format 118 from distillation engine 108, and render the compressed format 118 on display device 112. In some embodiments, the real-time rendering application 110 is within a game engine such as Unreal Engine or Unity. A component to decode the compressed format 118 is available within the framework of the game engine, which ultimately renders a 3D model from the compressed format 118, either static or for each frame of video. In such embodiments, any application can be built within the game engine. A few examples include games, VR/AR/MR experiences, and virtual production (special effects for 2D filmmaking).

In some embodiments, the real-time rendering application 110 is part of a web page or app. In some embodiments, the real-time rendering application 110 renders all or a portion of a web page as a 3D view into the corresponding scene (static or video), by decoding an image or video into a texture, and then transforming the texture into 3D geometry via shaders.

In some embodiments, the web page can be accessed in a VR/AR/MR/XR-enabled web browser. In such cases, the user may see a typical 2D web page superimposed on the real world (as in AR or MR), or in a virtual environment in VR. Within the 2D web page the Real-Time Rendering Application can display a 2D view of the 3D scene. It can also display a button that says “Enter VR” (or similar), such that when the user interacts with the button (or any other suitable interaction) they enter a fully or partially immersive mode (instead of a 2D viewing mode), where some or all of their environment is replaced with the 3D scene that is rendered by the real-time rendering application 110.

In some embodiments, the real-time rendering application 110 generates images for the user's eyes in a head-mounted display, which respond to the user's head motion with 6 degrees of freedom. 6DOF rendering is obvious when working directly with a radiance field, but the challenge addressed by the systems and methods described herein includes how to maintain 6DOF rendering in a compressed format (e.g., compressed format 118), and configuring the real-time rendering application 110 to run on more limited devices (e.g., display devices with limited computing power) and within the constraints of web streaming. 6DOF rendering is necessary to mitigate motion sickness caused by conflict between a user's perception of motion from their eyes and vestibular system.

In some embodiments, the display device 112 is a 2D screen or monitor, such as is used with a desktop or laptop computer. In such cases, the user may control their point of view in the scene with a keyboard or mouse. The display device 112 may be the 2D screen of a phone or tablet. The user may control their point of view by tilting or touching the device.

In some embodiments, the display device 112 is a head-mounted display (VR/AR/MR/XR), and the real-time rendering application 110 allows the user to interact with the 3D scene with their hands (or controllers), by performing pinch and drag gestures in 3D with one or both hands to translate, scale, and rotate the scene in 3D. This capability is only possible with 6DOF rendering; it is not possible with conventional VR video formats such as monoscopic 360 or VR180. The process is analogous to the typical gestures that users perform on 2D mobile devices, but the systems and methods described herein extend this concept to 3D/6DOF media. Other examples of 3D gesture interactions include swiping to advance to the next scene, or giving a thumbs up/down to rate content (these are done with hands in 3D, not on a 2D screen).

In some embodiments, the display device 112 is a glasses-free 3D display (also known as a “holographic display”) such as the Looking Glass Portrait or Lume Pad. Such devices have custom displays which direct light for different views to each eye of a user without glasses. In such examples, the real-time rendering application 110 works with the display device 112 to provide all necessary rendered views to drive the display device 112. For example, this can be done by implementing the real-time rendering application 110 as part of a web page in WebXR, and opening the web page in a system that is paired with a compatible 3D display.

In some embodiments, the radiance field engine 106 and distillation engine 108 run in the cloud, and may be accessed either by web or API endpoints. The radiance field engine 106 and distillation engine 108 may be configured to process a live stream of input video in order to produce a live streaming output in the compressed format 118 (possibly with some delay). In some embodiments, this is accomplished by parallelizing the radiance field engine 106 and distillation engine 108 to work on some part of processing multiple frames independently on multiple servers, then combining results into a live stream.

In some embodiments, the compressed format 118 uses its alpha channels to represent a “pass through” video which can be superimposed on top of the real world (either optically or via passthrough cameras in an AR/VR/MR/XR head mounted display). Unlike typical pass through video, the proposed invention includes the capability to render the pass through video with 6 degrees of freedom, and/or interactively re-position it within the real world. For example, the above capability can be used to render a virtual person superimposed on the real world, with 6 degrees of freedom in the rendering and placement.

In some embodiments, some or all of the radiance field engine 106, distillation engine 108, and real-time rendering application 110 are part of a single tool or application for creating and editing such media, e.g., for Mac, Windows, mobile, or spatial operating systems.

Aspects of the systems and methods described herein (e.g., computing system 102 and associated components including radiance field engine 106, distillation engine 108, and real-time rendering application 110) can be implemented using a variety of processing systems, including any combination of microcontrollers, microprocessors, digital signal processors (DSPs), field-programmable gate arrays (FPGAs), graphics processing units (GPUs) and so on.

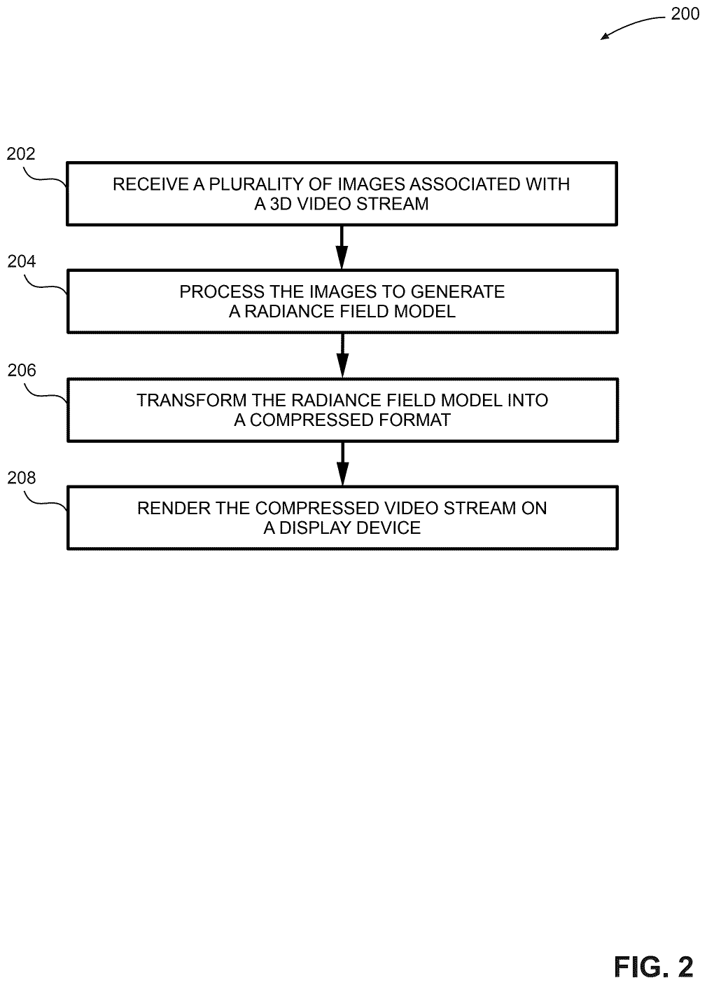

FIG. 2 is a flow diagram depicting a method 200 to perform NeRF video compression. Method 200 may include receiving a plurality of images associated with a 3D video stream (202). For example, computing system 102 (specifically, radiance engine 106), may receive images 114 from camera array 104.

Method 200 may include processing the images to generate a radiance field model (204). For example, radiance field engine 106 may process images 114 to generate radiance field model 116.

Method 200 may include transforming the radiance field model into a compressed format (206). For example, distillation engine 108 processed radiance field model 116 to generate compressed format 118.

Method 200 may include rendering the compressed video stream on a display device (208). For example, real-time rendering application 110 may receive compressed format 118, and render the associated compressed video stream on display device 112.

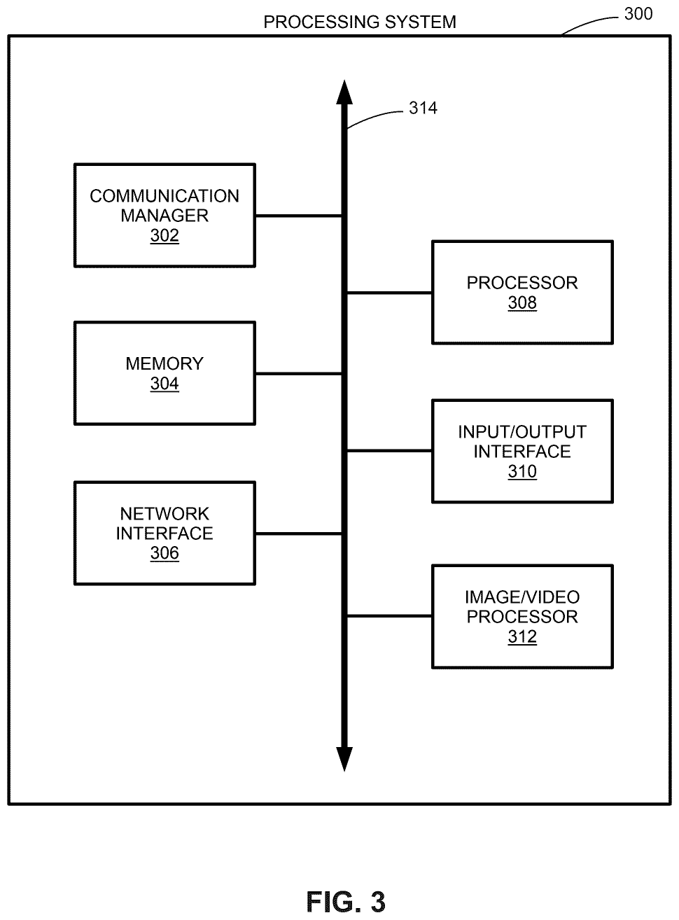

FIG. 3 is a block diagram depicting a processing system architecture 300 configured to implement aspects of the systems and methods described herein. As depicted, processing system 300 includes communication manager 302, memory 304, network interface 306, processor 308, input/output interface 310, image/video processor 312, and system bus 314. Processing system architecture 300 may be used to implement, for example, aspects of computing system 102.

In some embodiments, communication manager 302 is configured to manage communication protocols and associated communication with external peripheral devices as well as communication with other components in processing system 102. For example, communication manager 302 may be responsible for generating and maintaining respective communication interfaces between computing system 102 and camera array 104, between computing system 102 and display device 112, and between computing system 102 and other external devices and/or systems not depicted in FIG. 1.

Memory 304 may be configured to store data associated with computer system architecture 100 (specifically, computing system 102). For example, memory 304 may be used to store data associated with images 114. In one aspect, memory 304 includes both long-term memory and short-term memory. Memory 304 may be comprised of any combination of hard disk drives, flash memory, random access memory, read-only memory, solid state drives, and other memory components.

Network interface 306 may be configured to interface processing system 300 with other devices and/or computer networks. Network interface 306 support any combination of wired and wireless connectivity/communication protocols such as Ethernet, Wi-Fi, Bluetooth, ZigBee, etc.

A processor 308 included in some embodiments of processing system 300 is configured to perform functions that may include generalized processing functions, arithmetic functions, and so on. Processor 308 is configured to process information associated with the systems and methods described herein. Processor 308 may be configured as any combination of microcontrollers, microprocessors, digital signal processors (DSPs), field-programmable gate arrays (FPGAs), graphics processing units (GPUs) and so on.

Input/output interface 310 allows other devices or a user to interact with embodiments of the systems described herein. Input/output interface 310 may include any combination of user interface devices such as a keyboard, a mouse, a trackball, one or more visual display monitors, touch screens, incandescent lamps, LED lamps, audio speakers, buzzers, microphones, push buttons, toggle switches, and so on. Input/output interface 310 may alco include interfaces such as USB, Thunderbolt and Fire Wire that enable processing system 300 to interface with different devices.

Some embodiments of processing system 300 include image/video processor 312. Image/video processor 312 may be configured to process one or more image and/or video stream(s) (e.g., images 114). Image/video processor may include any combination of graphical processing units (GPUs), neural processing units (NPUs), and other kinds of image/video processing architectures.

System bus 314 communicatively couples the different components of processing system 300, and allows data and communication messages to be exchanged between these different components.

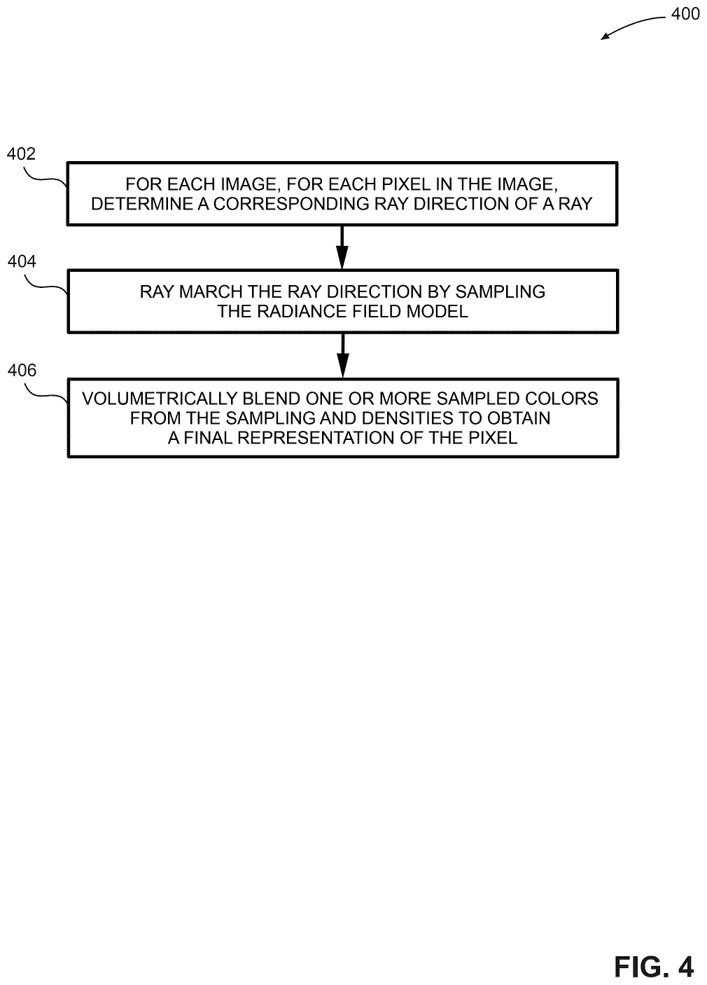

FIG. 4 is a flow diagram depicting a method 400 to obtain a final representation of a pixel. Method 400 may be implemented by distillation engine 108 as a part of converting radiance field model 116 into compressed format 118. Method 400 may include for each image, for each pixel in the image (e.g., each image in images 114), determining a corresponding ray direction of a ray (402).

Method 400 may include ray-marching the ray direction by sampling radiance field model 116 (404). Method 400 may include volumetrically blending one or more sampled colors from the sampling and densities to obtain a final representation of the pixel (406). This final representation may be for each pixel in each frame of compressed format 118.

In an aspect, images 114 include lossy compression, no alpha channels, no more than 8-bits/channel, no multi-view encoding, 422 chroma subsampling, and avoid the use of additional data streams (which are not trivial to decode or perfectly synchronize in all browsers).

In one aspect, computing system 102 is configured to estimate a volumetric representation and compress it into a streamable format in reasonable amount of time on a single workstation, and to do this with roughly “8K” resolution which is now expected in VR video (given that some users are sensitive to resolution and may prefer higher resolution video even if it is not 6DOF; high resolution being key to adoption). Computing system 102 may also be configured to ingest camera data from a wide variety of camera systems, ranging from monoscopic capture with phones to light field camera arrays.

NeRFs can be used for reconstructing a 3D model from one or more images of a scene, and enabling photorealistic novel view synthesis. This is accomplished by using a neural net to represent a radiance field, which maps a 3D point and ray direction to color and density, then training the net by minimizing a loss between predicted pixel colors obtained by differentiable volumetric rendering, and ground truth colors from pixels in real images. Some areas of active research for NeRF include extensions to time-varying scenes, and real-time rendering.

LDIs are another representation for novel view synthesis. LDIs consist of a set of layers, each of which has data associated with color and alpha channels, and a depth map which defines its 3D geometry. The systems and methods described herein (e.g., distillation engine 108) use properties of NeRFs and LDIs to generate compressed format 118. Aspects of computing system 102 include the following features:
Baking neural radiance fields into layered depth images with only a few layers, which enables extremely fast rendering of photorealistic novel views within a limited viewing volume.
Encoding LDIs with immersive field(s) of view and high spatial resolution (in a foveated center region) using inflated equiangular projection, and encoding inverse depth maps with 12-bits of accuracy in a lossy 8-bit/channel container. A sequence of such LDIs can be encoded with universally supported features of conventional video codecs.

Equirectangular projection is widely used in virtual reality video and photos to wrap a rectangular image around a sphere or half of a sphere. For example, the VR180 format, which has become increasingly popular in recent years, consists of a stereoscopic pair of images (one for each eye) in equirectangular projection, with 180° horizontal and vertical field of view.

Equirectangular projection is used for both 360° and 180° content. Equirectangular projection is arguably not the best choice for 180° content, because it has the lowest pixel density in the forward direction, and higher pixel density in the peripheral part of the view. This is the opposite of what is desired, because users are expected to mostly look forward. An alternative is equiangular projection, which is less commonly used to deliver immersive media, and more often used to represent fisheye lenses. Equiangular projection has a desirable property of putting more pixel density in the forward direction compared with equirectangular.

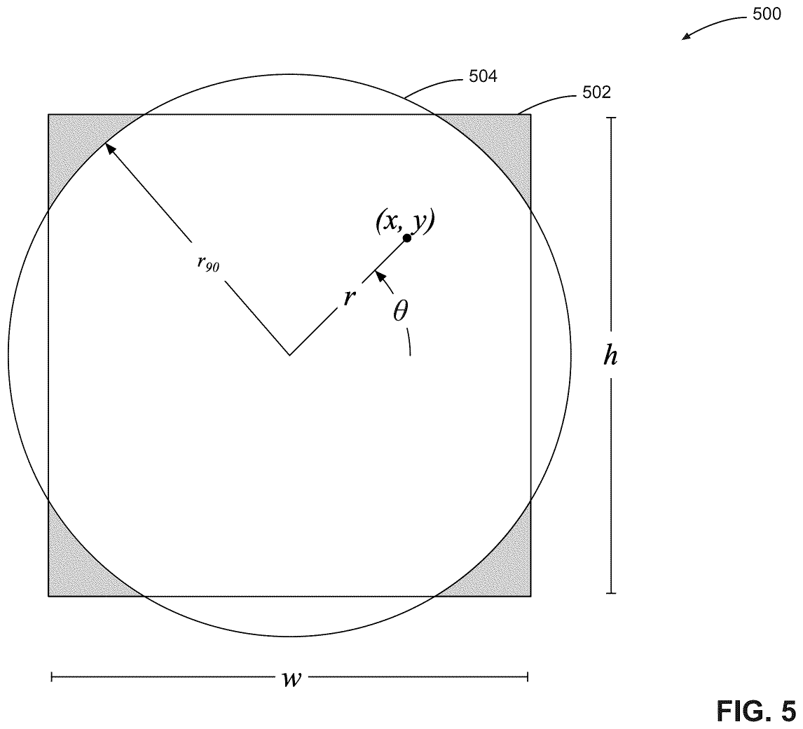

FIG. 5 is a geometric representation 500 of a two-dimensional (2D) image view of an equiangular projection. As depicted, geometric projection 500 shows a 2D image 502. Image 502 is shown to have a width w and a height h. Image 502 may be generated by camera array 104. A pixel with coordinates (x, y) may be a pixel within image 502. The coordinates (x, y) may be referenced to a predefined coordinate system, and may be associated with a range and angle (r, θ) in polar coordinates, referenced to the coordinate system. In geometric representation 500, a radius r₉₀ of image circle 504 as captured by camera 104 may exceed the image dimensions w and h.

Geometric representation 500 illustrates how equiangular projection defines a correspondence between pixel coordinates (x, y) in a 2D image with dimensions w×h, and a ray direction in 3D space d(x, y). An equiangular projection can be parameterized in terms of a “focal length” but it is usually more convenient to specify r₉₀, the radius in pixels at which the angle is 90° off forward (for 180° total FOV). The pixel coordinate (x, y) is rewritten in polar coordinates relative to the image center as (r, θ).

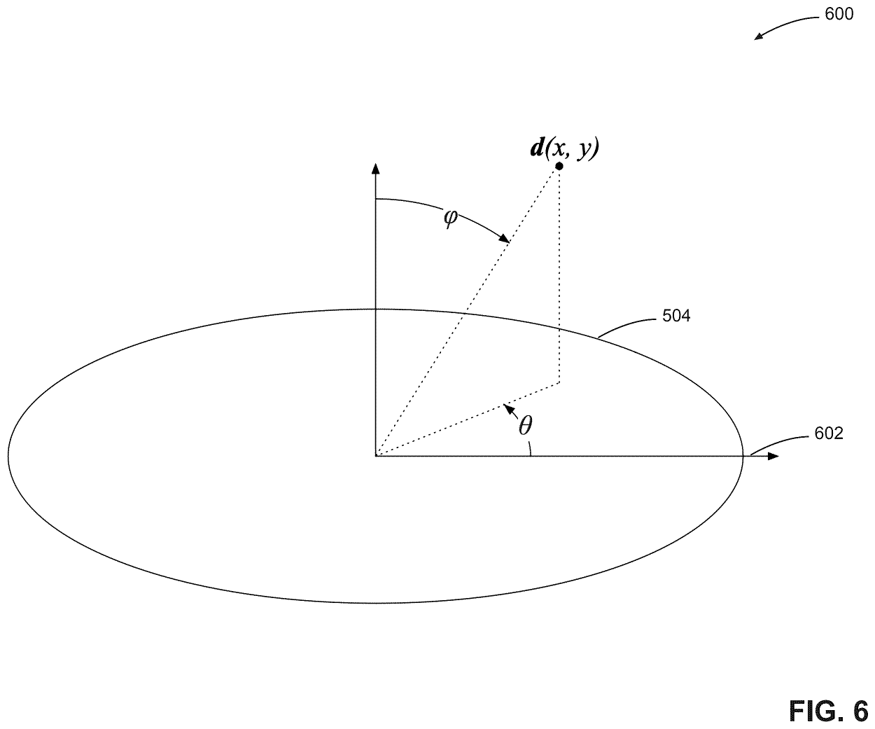

FIG. 6 is a geometric representation 600 of a 3D view of equiangular projection 500. Geometric representation 600 depicts image circle 600 and phase angle θ, which is now an azimuth angle. Geometric representation 600 also depicts angle off forward φ. Point (x, y) is on a ray joining the origin of a predefined coordinate system with point (x, y). This point is shown to be at a distance of d(x, y) from the origin of the coordinate system.

In the 3D geometric representation 600, the corresponding ray direction is written in spherical coordinates using the angle θ, and the angle off forward ϕ, where

$$φ = \frac{π}{2} {r}^{′} , where {r}^{′} = \frac{r}{{r}_{90}} . \qquad ( 1 )$$

Then, the ray direction (using OpenGL coordinate conventions) is

$$d ( x , y ) = [ \begin{matrix}cos ( θ ) sin ( φ ) \\ sin ( θ ) cos ( φ ) \\ - cos ( φ )\end{matrix} ] . \qquad ( 2 )$$

The equiangular projection can be modified to place even more pixel density in a forward direction, as described herein.

With equiangular projection, it is typical to use a square image (w=h), and

$${r}_{90} = \frac{w}{2} ,$$

which fits the circle corresponding to a 180° field of view exactly in the square image. In some aspects, it useful to use

$${r}_{90} = S \frac{w}{2} ,$$

where S is a scaling parameter that can be chosen as a design parameter. Geometric representation 500 illustrates a case where S>1, and the image circle does not fit inside the image. Each of the horizontal and vertical FOV is less than 180°; this is a tradeoff that produces higher pixel density at a fixed resolution. In some embodiments, S=1.15 can be used for slightly less than 180° FOV (but still enough to be “immersive”), while offering slightly higher pixel density.

### Inflated Equiangular Projection

Equiangular projection puts higher pixel density compared with equirectangular in the forward direction, which is desirable. However, this idea can be extended further by introducing “inflated equiangular” projection, which further magnifies the part of the scene in the forward direction, with a tradeoff of reducing pixel density in the peripheral directions. Equation (1) then changes to

$$φ = \frac{π}{2} [ β {r}^{′} + ( 1 - β ) {r}^{′γ} ] , \qquad ( 4 )$$

where β∈(0,1] and γ>1 are aesthetic parameters which control the shape of inflation. In one aspect, values of β=0.5 and γ=3 are utilized. It can be shown that that the pixel densities between an inflated equiangular image and an equirectangular image are similar (in the forward direction), despite the much lower resolution used with inflated equiangular projection.

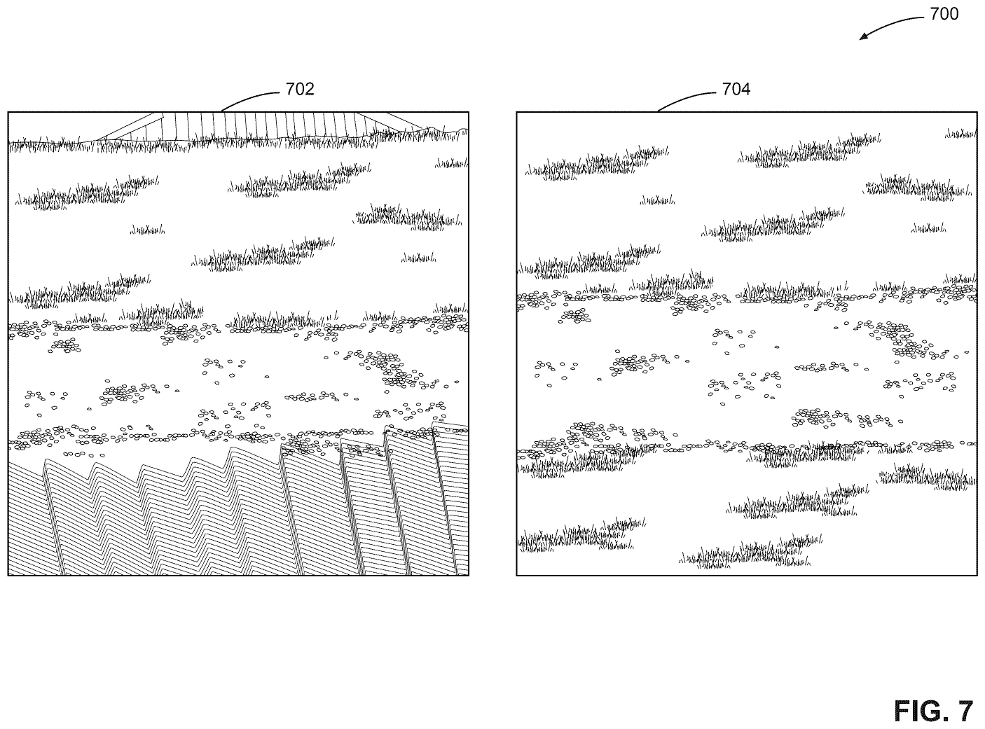

FIG. 7 is an illustration 700 comparing an 8-bit rendering with a 12-bit rendering. As depicted, illustration 700 shows a rendering of an identical LDI, with an inverse depth map stored in 8 bits 702, and an inverse depth map stored in 12 bits 704. As seen in illustration 700, the inverse depth map stored in 8 bits 702 shows noticeable (undesirable) staircase artifacts in the associated rendering. Hence, a 12-bit rendering using an inverse depth map stored in 12 bits is a more desirable storage format as compared to the 8-bit counterpart.

### 12-Bit Inverse Depth in an 8-Bit Container

In one aspect, immersive LDIs are stored using universally supported features of standard formats such as PNG, JPG, and MP4, while working within the constraints of deployment environments including web/JavaScript, rendering in OpenGL, and in game engines, etc.

Depth values t naturally have values in [0, ∞), which cannot be stored in universal web formats. Therefore it is useful to store depth maps using encoded inverse depth values, defined as

$$v = {[ \frac{K}{t} ]}_{01} \qquad ( 4 )$$

where [·]₀₁ denotes clamping to [0,1], t is a depth or distance in units of meters, and K is a constant that adjusts the scaling of the inverse depth map (in one aspect, K=0.3). The value of v is stored as the intensity of a pixel in an image or video file, and is quantized to the bit-depth of the container. 8-bit/channel is fairly universal, whereas 10-bit (or more) video compression codecs are not supported on all browsers and devices, and even when supported, may come with significant performance tradeoffs.

However, encoding inverse depth with 8-bit accuracy produces unacceptable staircase artifacts, as illustrated in rendering 702 when rendering the resulting LDI from novel views. With a 12-bit encoding of v, the staircase artifacts are much less apparent, as shown in rendering 704. Therefore it is desirable to store a 12-bit encoding of v in an 8-bit/channel image or video format.

However, there are challenges to achieving such a 12-bit encoding. First, video compression codecs often use chroma-subsampling, so packing data into different color channels of the same pixel should be avoided, and instead only luminance channel(s) should be used. Second, the data may be stored with lossy compression, and simply encoding as a texture and then decoding in OpenGL may be a lossy operation in terms of preserving individual bits. Lossy compression for color images may be acceptable, but corruption of the most significant bits of the depth map can produce major artifacts.

One approach is to store two 8-bit values in different regions of a container image or video, which can be reassembled into a 12-bit value, using an encoding that is robust to some corruption. In one aspect, the inverse depth map is stored at half the resolution of the color map, to make space for storing these two copies. In typical use, this does not come with any loss of quality when rendering the LDI in realtime, because realtime rendering is done via a triangle mesh that is lower resolution than even the half-resolution depth map (due to limitations of the rendering devices). A higher resolution depth map would get aliased in such a case.

In one aspect, a bit-level logic associated with a 12-bit encoding process may include the following lines of C++ code:

```
void encode12 (
  const float v ,
  uint8 _t& low,
  uint8 _t& high)
{
    int iv = v * ( ( 1 << 12) − 1 ) ;
    high = iv >> 8 ;
    low = iv & ( ( 1 << 8) − 1 ) ;
    low = ( iv & (1 << 8 ) ) == 0 ? low : 255 − low ;
    high = high * 16 + 8 ;
}
```

In one aspect, a bit-level logic associated with a 12-bit decoding process may include the following lines of C++ code:

```
float decode12 (
uint8_t low ,
uint8_t high )
{
  high = high / 1 6 ;
  low = (high & 1) == 0 ? low : 255 − low ;
  int i12 = (low & 255) | ( ( high & 15) << 8 ) ;
  float v = float (i12) / float ( ( 1 << 12) − 1 ) ;
  return v ;
}
```

In an aspect, the encoding and decoding processes encode and decode the 12-bit inverse depth values in to “high” and “low” eight-bit values.

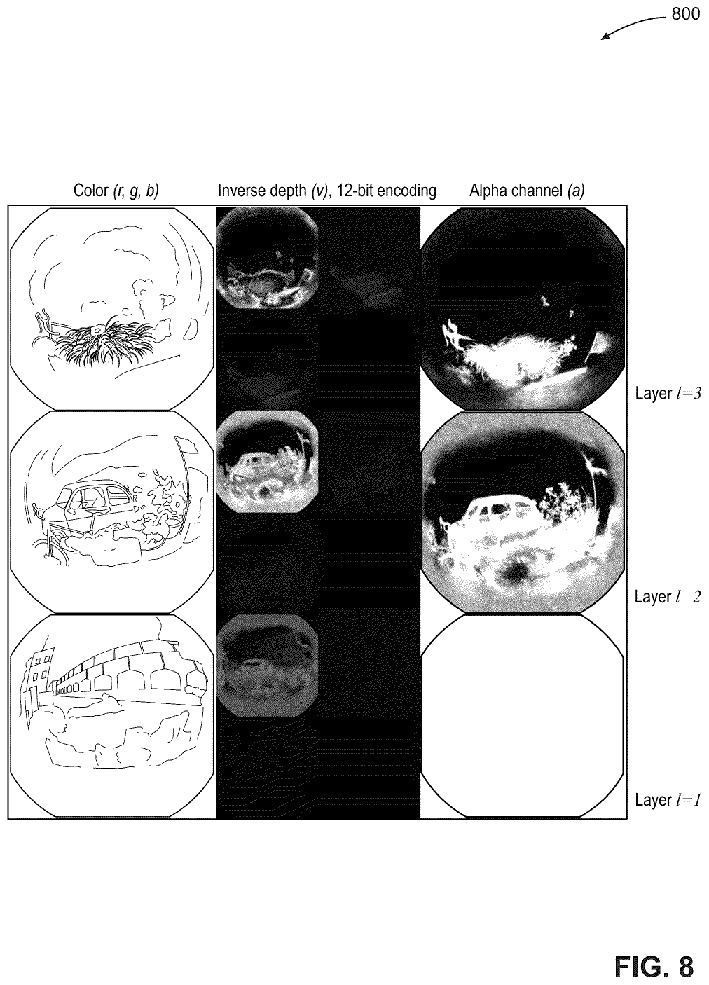

FIG. 8 is an illustration 800 depicting an example of a compressed image format that contains a layered depth image. Illustration 800 depicts the compressed image format in an LDI3 format, which uses inflated equiangular projection, and 3 layers with color, alpha, and 12-bit inverse depth encoded into an 8-bit container.

In illustration 800, the first column depicts a rendition in RGB color space. The second column depicts an inverse depth (v), 12-bit encoding. The third column depicts alpha channels (a). At the same time, each row depicts a different layer l in the image (l=1, 2, 3).

### The LDI3 Format

LDI3 is a format for immersive layered depth images and video which incorporates the ideas described above, and is optimized for video on devices with limited GPU power, (e.g., contemporary devices such as Meta Quest 2, Quest 3, Quest Pro, Apple Vision Pro, mobile phones and tablets, etc.). Across these VR devices, a baseline set of video decoding capabilities is identified, and the LDI3 format is optimized to work within these limitations. The maximum resolution video that can be decoded is 5760×5760 at 30 or 60 frames per second, 8 bit, RGB (not RGBA). Mobile phones may have a lower maximum resolution, e.g., 1920×1920, but an LDI3 frame can be constructed at the full resolution, and then downscaled. In such a case, the associated 12-bit inverse depth encoding does not break or get corrupted due to the resizing operation. A subsequent step in the design process is to determine how to appropriately utilize these 5760×5760 pixels.

In one aspect, with LDI3, a number of layers can be chosen as N₁=3 because a 3×3 grid of 1920×1920 cells can be stored in a 5760×5760 array. With inflated equiangular projection, the center of a 1920×1920 image has similar pixel density to “8K” VR180 in equirectangular projection. Increasing the number of layers beyond three would come with a tradeoff in spatial resolution which may be unacceptable to most users (resolution is one of the most important qualities of immersive video that users notice). Furthermore, preliminary experiments suggest that WebXR/OpenGL rendering of more than three layers is not fast enough on current mobile VR devices due to alpha blending operations. So it appears that on current hardware, three layers is a good design compromise. More layers could enable representing more geometrically complex scenes, but it can be shown that with careful construction, three layers is sufficient to achieve good novel view synthesis on many real-world scenes.

Illustration 800 depicts an example of the LDI3 format. Each row corresponds to one layer. The left column stores the RGB color for the layer. The right column stores the alpha channel. The middle column stores inverse depth maps in 12-bit encoded format. Each 1920×1920 region in the middle column is divided into four cells, each half the size. The upper two of these store the high and low bits in the 12-bit encoding. The lower two are unused; an 8-bit version of the inverse depth map is stored in one of these cells just for human readability, and the other is left empty. These cells could be used to store or display additional data in future work, e.g., to encode data for view-dependent effects.

### Rendering LDI3 in Real-Time

Given an image or video in LDI3 format, the main use is to be able to render it from novel views in real time, on a variety of platforms such as WebXR (OpenGL), and game engines such as Unity and Unreal Engine. In one aspect, LDI3 can be rendered in a 3D graphics engine such as OpenGL, which uses vertex and fragment shaders.

The main idea is to construct a triangle mesh for half a unit sphere, and store the LDI3 image in a texture (which may update each frame for video). Then, a vertex shader is used to scale each vertex so that instead of being a unit vector, its length is the decoded value of the inverse depth map for that layer. The initial vertex positions are constructed by iterating over a grid in pixel coordinates, and applying equation 2 to get the corresponding ray direction. The vertex shader must implement the bit-level decoding logic seen in the C++ code for the decoding process described above. The fragment shader is relatively simple; this aspect essentially gets the RGB and alpha channels from their respective regions of the LDI3 encoding and uses those as the fragment color.

The alpha channel for the farthest layer is optional; if this alpha channel is unused, the fragment shader can be optimized to not read the alpha channel from the texture, and not perform alpha blending for that layer, and this space in the LDI3 format is also unused and available for other purposes. If the alpha channel of the last layer is used, it enables other applications such as “pass through” video for mixed reality.

### Volumetric Rendering of Radiance Fields

A radiance field is a function which maps a position in 3D space x, and a ray direction d, to a color c=(r, g, b), and a density σ, i.e.,

$$F ( x , d ) = ( c , σ ) . \qquad ( 5 )$$

In practice, F is often represented by a neural net or data structure with some neural components.

To render a pixel (x, y) in an image, the process may start with a camera model which associates the pixel with a ray direction d(x, y), and a ray origin o, then evaluate the radiance field F at N samples along the ray, at distances tᵢ for i=1 . . . . N. At points o+tᵢd, the sampled radiance values are (cᵢ, σᵢ). The density values o are related to alpha values in traditional alpha compositing; based on the distance between consecutive samples δᵢ=tᵢ₊₁−tᵢ, the alpha value is

$${α}_{i} = 1 - exp ( - {σ}_{i} {δ}_{i} ) . \qquad ( 6 )$$

The color for the pixel from volumetric rendering is a linear combination of the colors sampled from the radiance field,

$$C ( x , y ) = {\sum }_{i = 1}^{N} {w}_{i} {c}_{i} . \qquad ( 7 )$$

The weights in the linear combination are

$${w}_{i} = {α}_{i} {\prod }_{j = 1}^{i - 1} ( 1 - {α}_{j} ) \qquad ( 8 )$$

$$= {α}_{i} {T}_{i} , where {T}_{i} = exp ( - {\sum }_{j = 1}^{i - 1} {σ}_{j} {δ}_{j} ) . \qquad ( 9 )$$

Tᵢ is referred to as transmittance. Equation 9 is more common in theoretical studies, while equation 8 more closely resembles most code (e.g., in a practical implementation).

It is also common to render a depth map along with an image, and this is typically done by linearly combining the distances along the ray, i.e.

$$t ( x , y ) = {\sum }_{i = 1}^{N} {w}_{i} {t}_{i} . \qquad ( 10 )$$

It will be necessary to modify these equations for the purpose of baking an LDI.

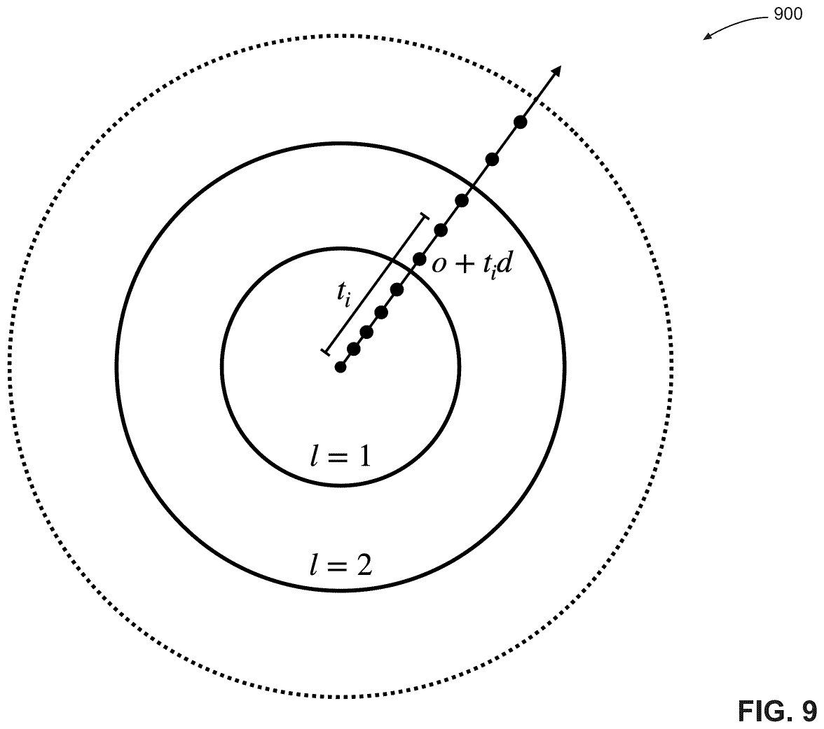

FIG. 9 is a geometric representation 900 of a divided space. As depicted, geometric representation 900 shows a radiance field sampled at multiple points along a ray. Each point belongs to a single layer of the LDI.

Baking Radiance Fields into LDIs

For each pixel and layer in an LDI, a color, alpha channel, and inverse depth value are stored. Layers are indexed l=1 . . . . Nₗ. At pixel (x, y), in layer l, the LDI stores:

$$LDI ( l , x , y ) = ( {C}^{l} , {a}^{l} , {v}^{l} ) , \qquad ( 11 )$$

Where C^{l}=(r, g, b) is a color, a^{l} is an alpha channel, and v′ is an inverse depth.

A next step in the process is to construct an LDI (l, x, y) from a radiance field F (x, d). For each layer l=1 . . . . Nₗ and each pixel (x, y) in the LDI:
A ray origin o and ray direction d(x, y) are obtained,
The radiance field is sampled at distances tᵢ along the ray to obtain (cᵢ, σᵢ), and
A modified version of the rendering equations (5) through (10) are used to calculate (C^{l}, a^{l}, v^{l}).

One approach to constructing an LDI from a radiance field is based on the concept presented in geometric representation 900. For each layer l, define a lower and upper bound tₘᵢₙ(l) and tₘₐₓ(l), and limit contributions to volumetric rendering to samples within that range of distances. This changes the a values associated with samples of the radiance field,

$${\hat{α}}_{i}^{l} = \{ \begin{matrix}{α}_{i} & if {t}_{min} ( l ) < {t}_{i} \leq {t}_{max} ( l ) \\ 0 & otherwise\end{matrix} . \qquad ( 12 )$$

where αᵢ is defined in equation 6, and \hat{α}ᵢ^{l} denotes the modified version used to construct layer l of the LDI.

A goal is to calculate=(C^{l}, a′, v′) for each layer in the LDI. Starting with the alpha channel a′ (not to be confused with aassociated with samples from the radiance field) gives:

$${a}^{l} = {\sum }_{i = 1}^{N} {\hat{w}}_{i}^{l} where {\hat{w}}_{i}^{l} = {\hat{α}}_{i}^{l} {\prod }_{j = 1}^{i - 1} ( 1 - {\hat{α}}_{j}^{l} ) . \qquad ( 13 )$$

Note that a is not necessarily 1 in every layer of the LDI, because the region of 3D space corresponding to that layer may be empty (near zero σ) or partially transparent. The weights ŵᵢ^{l} do not sum to 1 in such cases.

Weights not summing to 1 requires subtle modifications to the equations for color and depth to avoid biases and artifacts. Similar to equation 7, the color is a linear combination of colors from sampled points, but it is necessary to normalize to avoid tinting colors toward black in regions where a<1.

$${C}^{l} = \frac{{\sum }_{i = 1}^{N} {\hat{w}}_{i}^{l} {c}_{i}}{{a}^{l} + ϵ} , where ϵ = {e}^{- 10} . \qquad ( 14 )$$

A naive approach to construct the inverse depth v for a layer is to compute depth according to equation 10, then apply equation 4. The problem is that when a<1, the depth estimated by equation 10 is biased toward 0, which causes the silhouettes of objects, where the LDI transitions from a=1 to a=0, to be closer to the origin than the object. It does not matter what the value of v is; if a=0 because that part is invisible, but when 0<a<1 it distorts the LDI rendering in a way that looks like a mistake/error or an anomaly in the algorithm.

This problem can be addressed by linearly combining inverse depths,

$${v}^{l} = {\sum }_{i = 1}^{N} {{\hat{w}}_{i}^{l} [ K / ( {t}_{i} + ϵ ) ]}_{01} , where ϵ = 1 {e}^{- 3} . \qquad ( 15 )$$

When 0<a<1, v is biased toward 0, and an inverse depth of 0 corresponds to a depth of ∞, which causes the silhouettes of objects to recede into the distance just as their alpha channels fade from 1 to 0. This approach produces results which are not obviously distorted.

When baking a radiance field into an LDI, some consideration must be given to the sampling strategy. In one existing approach, a “fine” radiance model, and smaller, faster “coarse” radiance model are both trained on photometric loss. First, N_{c} samples are taken from the coarse model using a stratified sampling strategy, then the weights (e.g., as calculated in equation 8) are computed based on these samples, which estimates how much they contribute to the final image. The weights are normalized to form a probability density function, from which N_{f} further samples are drawn. This can be viewed as importance sampling from a distribution which depends only on transmittance.

One issue with only using importance samples is that behind any solid object, the weights are zero, so there will be zero importance samples in that region. Some samples may need to be taken from occluded parts of the scene, to create a proper multi-layered effect. In one aspect, a contemporary proposal network sampling strategy is implemented, while training the radiance model (only using the importance samples), but then during LDI baking, both the initial samples to the proposal network and the importance samples are used. More advanced ideas are possible, but this approach suffices to avoid completely undersampling occlusions.

### Locally Adaptive Distance Bounds

Geometric representation 900 illustrates a case where the bounds tₘᵢₙ (l) and tₘₐₓ(l) are constant for all rays, resulting in each layer corresponding to a spherical shell around the origin. This approach is sufficient for some scenes, and has a desirable property of producing clean alpha channels, which could be edited with existing video tools. However, every ray can have different bounds, and many heuristics are possible for selecting these bounds. Well-chosen bounds can reduce stretched-triangle artifacts while keeping the number of layers Nₗ small. For example, the following strategy may be employed:
Render a depth map using equation 10 in inflated equiangular projection,
For each pixel, compute quantiles of the depth values in a neighborhood around the pixel. One approach uses the 33% and 66% values as tₘᵢₙ (l=2) and tₘₐₓ (l=2), which

$$\frac{1}{8}$$

are evenly spaced for M1=3. As an optimization, the depth map may be rendered at resolution. Then, a 31×31 neighborhood may be implemented. Finally, the quantile map can be rescaled back to full size.

### NeRF Training

In an aspect, contemporary NeRF training techniques may be modified to implement the systems and methods described herein, with a goal being to modify the model computing F(x, d)=(c,σ).

In one aspect, a radiance field model may be represented with a neural multi-resolution hash map and a small multi-layer perceptron. The hash map encodes an input point x to a feature h∈R^{m}. The resolution at the lowest level is 16, and it increases by a factor of 1.382 for 16 levels, with 2 features per level (hence m=32). The hash map has 219 entries per level. Because a focus is on unbounded scenes, a contraction operator may be used to map points in 3D space to a unit cube before encoding via the NGP hash map. The hash feature goes through a 2-layer multi-layer perceptron (MLP) with relu activation in the first layer, and no activation in the second layer to form the “geometry” feature g∈R⁶⁴.

For view-dependent effects, the ray direction d may be encoded using a 4th degree spherical harmonic encoder, which gives a feature s∈R²⁵. A joint optimization of a per-image latent code qⱼ ∈R¹⁶ where j indexes images may be performed.

The color head of the model outputs c. The geometry feature, the spherical harmonic direction feature, and the per-image latent code are concatenated to form the input [g, s, qⱼ] to the color head, which is a 3-layer MLP with relu activation in the first two layers, and sigmoid in the last layer. All of the MLP layers use 64 hidden neurons (including the layers for the geometry feature). The density component of the model output σ is TruncExp (g₀) where g₀ is the first element of the geometry feature.

One aspect may use a smaller density proposal network, where the hash map has a coarse scale of 16, increasing by a factor of 2, over 5 levels, with 2 features per level, and 217 entries per level. The proposal network maps an input point x to density σ, by first applying the contraction operator, then the hashmap, then a 2-layer MLP with relu followed by TruncExp activation and 32 hidden neurons.

In one aspect, instead of using a histogram loss function as implemented in contemporary systems, every k_{update}=10 regular batches of optimization, an additional batch of the same size is sampled, and σ is evaluated from both the full radiance model and the proposal model at each point of the batch's rays. Then a smooth L1 loss is used between the full and proposal model σ values. Only the proposal network parameters are updated during this step; the full radiance model is fixed. The motivation for this approach is that the purpose of the proposal model is to estimate transmittance to enable importance sampling, and the quality of the estimation is determined by how closely the proposal densities match the full model densities, therefore this difference is minimized.

One aspect may use importance sampling during training. Initial N_{c}=128 samples from the proposal network may be split into two groups of N/2. The first half are sampled with uniform stratified sampling between Zₙₑₐᵣ=0.2 and Z_{mid}=10.0, and the second half are stratified samples from inverse depth values between

$$\frac{1}{{Z}_{mid}} and \frac{1}{{Z}_{far}} ,$$

where Z_{far}=1000 (note these values may not correspond to any particular units; it depends on the dataset). After these initial samples, a further N_{f}=64 samples may be drawn using importance sampling from the weight distribution.

A defined occlusion regularization L_{occ} may be used, which penalizes density within a distance of 1 unit of a camera. This prevents a failure mode for training where each image is represented by a small cloud directly in front of the camera.

To improve generalization to novel views when training on only a few images, a regularization term similar to ray entropy loss may be included, which begins by normalizing the αᵢ values in each ray to form a probability density function,

$${\hat{α}}_{i} = \frac{{α}_{i}}{{\sum }_{i = 1}^{N} {α}_{i} + ϵ} . \qquad ( 16 )$$

Instead of computing an entropy of this distribution, the Gini index may be used, which produces slightly better results in preliminary experiments (it is anticipated that this approach more stable due to not using a log operation):

$${L}_{gini} = \frac{1}{N} {\sum }_{i = 1}^{n} ( 1 - {\hat{α}}_{i}^{2} ) . \qquad ( 17 )$$

As usual, there is a photometric loss term which compares predicted colors from the NeRF with ground truth pixels in the training data, which is denoted by denote L_{rgb}. A smooth L1 loss may be used here instead of quadratic loss. The overall objective is

$$L = {L}_{rgb} + {λ}_{occ} {L}_{occ} + {λ}_{gini} {L}_{gini} , \qquad ( 18 )$$

$$where {λ}_{occ} = 1 {e}^{- 3} and {λ}_{gini} = 1 {e}^{- 4} .$$

In one aspect, three instances of the Adam optimizer may be used, one for the radiance model, one for per-image latent codes, and one for the proposal model, with initial learning rates of 1e⁻², 1e⁻⁴, and 1e⁻² respectively, and weight decay strength 1e⁻⁸, 1e⁻⁴, and 1e⁻⁶. The optimizer for the radiance model applies only weight decay to the MLP parameters, not the hash map parameters. All use E=1e⁻¹⁷. Training may be conducted for 10000 batches with 4096 rays per batch. The learning rates are adjusted according to the following schedule: during the first 100 “warmup” iterations, the learning rate ramps linearly from 0.01×the initial value up to the initial value. Then at milestones of

$$\frac{1}{2} , \frac{3}{4} , and \frac{9}{10} ,$$

of the total iterations, the learning rates decay by a factor of 0.333.

In an aspect, a NeRF system based on the systems and methods described herein (e.g., computing system 100) may be trained on existing image datasets. One such available image dataset includes several videos with a custom camera array consisting of 46 time-synchronized Yi4k action sports cameras distributed on the surface of a 92 cm diameter acrylic dome. These datasets illustrate several challenging phenomena for novel view synthesis, including volumetric effects (flames), thin structures, and reflections.

This dataset includes a pose and intrinsic parameters for each of the cameras, with some distortion parameters. As a preprocessing step, the images may be rectified to remove lens distortion before using them in a training pipeline. To render a video in LDI3 format, each frame of video may be treated as an independent frame, and a NeRF may be trained on the 46 images for that frame. The frame may then be baked into an LDI3 image. Finally, the sequence of LDI3 images may be encoded using conventional H.264 or H.265 compression (or ProRes if further editing is intended). In an aspect, all 46 images are used to train the NeRF, unlike contemporary approaches that are limited to a maximum of 7 images that can be used for training to avoid the contemporary training process becoming prohibitively expensive.

Another training dataset uses casually captured videos using a smartphone. One aspect includes capturing 10 static scenes using videos ranging from 4s to 20s in duration, using an iPhone 14 Max, with 4K resolution and 30 fps. The phone camera was held at arm's length, and moved in a square or circle shape to obtain variety of camera poses. The camera was set on its widest field of view setting, and had auto-exposure on. Before further processing, the videos were downscaled to a maximum width or height of 2048 (some being in a portrait orientation, while some were in a landscape orientation).

In an aspect, the Lucas-Kanade method may be used to track key-points between frames of video, then solve a bundle adjustment problem using Ceres to estimate the camera pose in each frame, jointly with the focal length. (It was assumed that since the captured videos were from an iPhone, they prerectified, so it is possible to achieve sub-pixel reprojection error while only estimating focal length and no other intrinsic camera parameters.) An iteratively re-weighted non-linear least squares objective was used to reduce the effect of outliers from bad keypoint tracking, or from moving objects in the scene such as foliage in wind, water ripples, or people.

After solving for camera poses in each frame of video, the dataset was reduced to n=30 images chosen to have maximal diversity in position using a farthest first traversal (this prevents overfitting when the camera dwells in one place longer than others during a video).

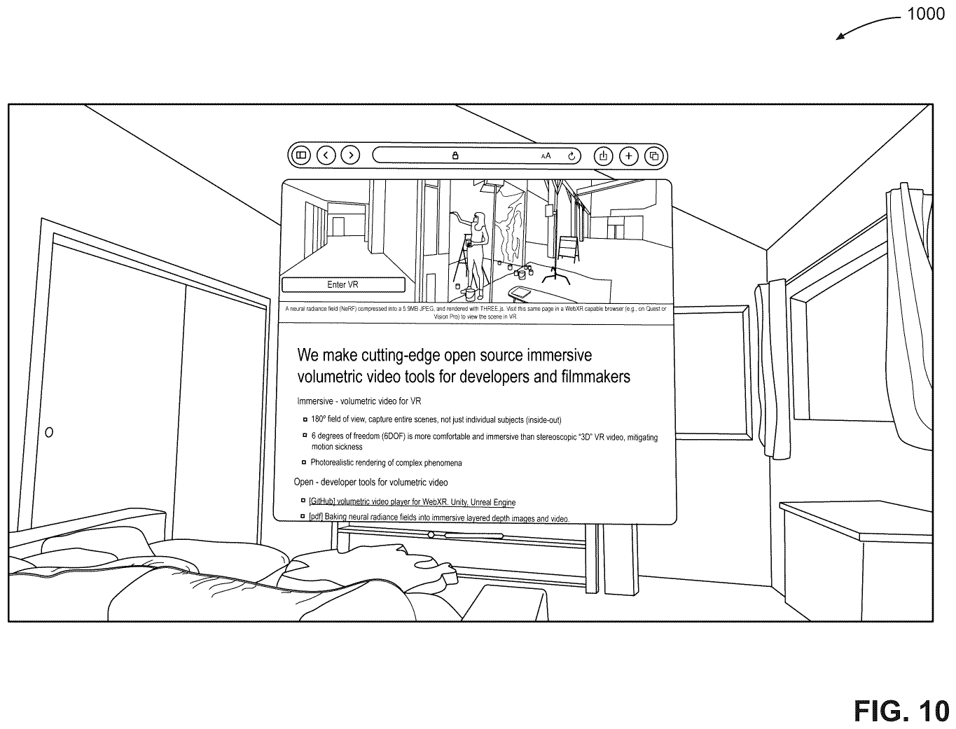

FIG. 10 is an illustration 1000 depicting an example of a computer-generated 2D rendering superimposed over a real-world rendering. As depicted, illustration 1000 depicts a 2D web page superimposed on top of the real world in a mixed reality headset using the systems and methods described herein. The 2D web page includes the Real-Time Rendering Application, which is showing a 2D view in this case. It also shows a button that says “Enter VR” (or similar), which the user can interact with to begin a fully immersive session viewing the scene.

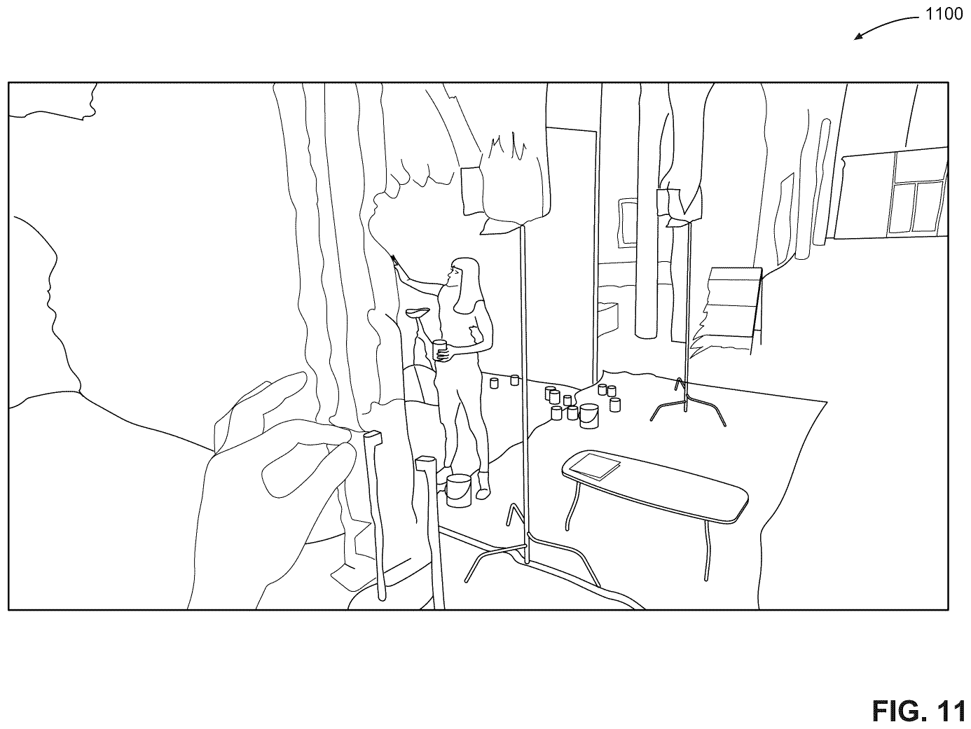

FIG. 11 is an illustration 1100 depicting a user view based on a user interaction with a VR rendition. As depicted, illustration 1100 shows what a user sees while in a VR headset which displays a Real-Time Rendering Application generated by the systems and methods described herein. The user's hands are visible. Here the user is performing a pinch gesture with the left hand, and the right hand is open. While pinching with a single hand, if the user moves their hand, the entire scene translates accordingly.

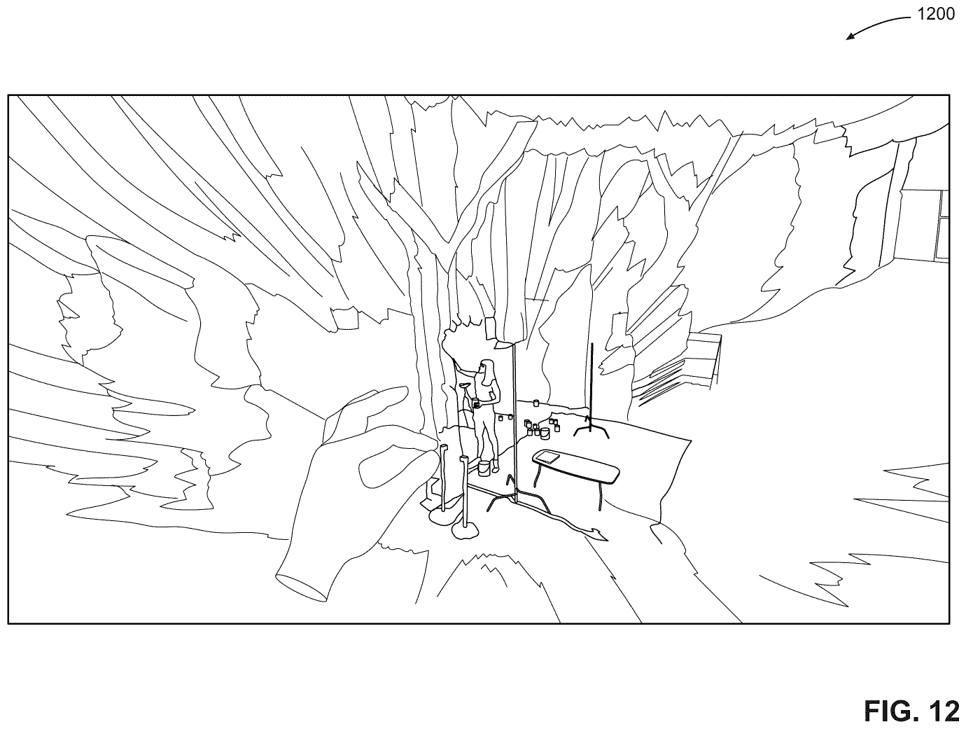

FIG. 12 is an illustration 1200 depicting a user view based on a user interaction with a VR rendition. As depicted, illustration 1200 shows a different interaction of the scene presented in illustration 1100, where the user is pinching and dragging with both hands simultaneously. Instead of translating the world, this interaction scales and rotates the world.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

What is claimed is:

1. A method comprising:
receiving a plurality of images;
processing the images to generate a radiance field model;
transforming the radiance field model into an image sequence in a compressed format; and
rendering the compressed image sequence on a display device.

2. The method of claim 1, wherein the compressed format further comprises a layered depth image with a plurality of layers.

3. The method of claim 1, wherein the transforming includes rendering the images in an inflated equiangular projection.

4. The method of claim 1, wherein the transforming further comprises using an error-correcting code to represent 12 bits of accuracy in one or more inverse depth maps associated with the images.

5. The method of claim 1, wherein the transforming further comprises storing two 8-bit values in different regions of a container image or video associated with the images, which can be reassembled into a 12-bit value.

6. The method of claim 1, wherein the images are associated with a three-dimensional (3D) video stream, and wherein the compressed image sequence is a compressed 3D video stream.

7. The method of claim 1, wherein the transforming further comprises:
for each pixel in each image, determining a corresponding ray direction of a ray associated with the pixel;
ray marching the ray direction by sampling the radiance field model; and
volumetrically blending one or more sampled colors from the sampling to obtain a final representation of the pixel.

8. The method of claim 1, wherein the compressed format uses one or more alpha channels associated with the compressed format to represent a pass-through video, and wherein the video is superimposed on top of a rendition of a real world around a user.

9. The method of claim 1, wherein the rendering is a 6 degree-of-freedom (6DOF) virtual reality (VR) rendering configured to mitigate motion sickness due to motion of a user's head.

10. The method of claim 1, further comprising parallelizing any combination of portions of the processing and the transforming to run on separate computing systems.

11. An apparatus comprising:
an imaging system configured to generate a plurality of images;
a computing system configured to:
process the images to generate a radiance field model;
transform the radiance field model into an image sequence in a compressed format to generate a compressed image sequence; and
preparing the compressed image sequence for rendering; and
a display device configured to:
render the compressed image sequence.

12. The apparatus of claim 11, wherein the compressed format further comprises a layered depth image with a plurality of layers.

13. The apparatus of claim 11, wherein the compressed format includes the images rendered in an inflated equiangular projection.

14. The apparatus of claim 11, wherein the transforming further comprises using an error-correcting code to represent 12 bits of accuracy in one or more inverse depth maps associated with the images.

15. The apparatus of claim 11, wherein the transforming further comprises storing two 8-bit values in different regions of a container image or video associated with the images, which can be reassembled into a 12-bit value.

16. The apparatus of claim 11, wherein the images are associated with a three-dimensional (3D) video stream, and wherein the compressed image sequence is a compressed 3D video stream.

17. The apparatus of claim 11, wherein the transforming further comprises the computing system being configured to:
for each pixel in each image, determine a corresponding ray direction of a ray associated with the pixel;
ray march the ray direction by sampling the radiance field model; and
volumetrically blend one or more sampled colors from the sampling to obtain a final representation of the pixel.

18. The apparatus of claim 11, wherein the compressed format uses one or more alpha channels associated with the compressed format to represent a pass-through video, and wherein the video is superimposed on top of a rendition of a real world around a user.

19. The apparatus of claim 11, wherein the rendering is a 6 degree-of-freedom (6DOF) virtual reality (VR) rendering configured to mitigate motion sickness due to motion of a user's head.

20. The apparatus of claim 11, further comprising parallelizing any combination of portions of the processing and the transforming to run on separate computing systems.

21. A method comprising:
receiving a radiance field associated with an image sequence, the radiance field further including a plurality of layers;
for each layer, defining an upper bound and a lower bound;
limiting one or more contributions to volumetric rendering to radiance samples from the image sequence that are within a range defined by the upper bound and the lower bound;
generating a sequence of modified alpha values associated with the image sequence based on the limiting; and
constructing a layered depth image (LDI) comprising a color, an alpha channel and an inverse depth, based on the modified alpha values.
